(19) United States
(12) Patent Application Publication
(10) Pub. No.: US 2011/0039162 A1
(43) Pub. Date: Feb. 17, 2011

(54) ALL-SOLID SECONDARY BATTERY AND POSITIVE ELECTRODE USED THEREFOR

(75) Inventor: Hideaki MAEDA, Minoo-shi (JP)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/849,993

(22) Filed: Aug. 4, 2010

(30) Foreign Application Priority Data
Aug. 11, 2009 (JP) 2009-186795
Jan. 15, 2010 (KR) 10-2010-0003929

(51) Int. Cl. H01M 10/0562; H01M 4/48; H01M 4/485; H01M 4/505; H01M 4/525

(52) U.S. Cl. 429/320; 429/231.95; 429/322; 429/223; 429/231.3; 429/218.1; 429/224; 429/231.1; 429/231.6; 429/319

(57) ABSTRACT

An all-solid secondary battery having excellent output characteristics and cycle characteristics, and a positive electrode used therefor includes a positive electrode active material which includes LiMeO₂. The Me includes at least one metal element. A variation rate of the lattice constant a and a variation rate of the lattice constant c between LiMeO₂ before the deintercalation of Li and Li₁₋ₓMeO₂ (0<X<0.8) after the deintercalation of Li are 1% or less, respectively.

### CROSS-REFERENCE TO RELATED APPLICATIONS

This application claims the benefit of Japanese Patent Application No. 10-2009-0186795, filed Aug. 11, 2009 in the Japanese Patent Office, and Korean Patent Application No. 10-2010-0003929, filed Jan. 15, 2010 in the Korean Intellectual Property Office, the disclosures of which are incorporated herein by reference.

### BACKGROUND

1. Field

Aspects of the present disclosure relates to an all-solid secondary battery and a positive electrode used therefor.

2. Description of the Related Art

Recently, due to their high stability, all-solid secondary batteries including a solid electrolyte that is a lithium ion conductor are drawing more attention than general lithium ion secondary batteries including a nonaqueous electrolyte solution prepared by dissolving a lithium salt in an organic solvent. That is, since a lithium ion conductor contained in the solid electrolyte is a single ion conductor in which only Li ions are migrated, side reactions and deterioration of all-solid secondary batteries occur less than in secondary batteries using the liquid electrolyte. Thus, all-solid secondary batteries have received attention as batteries for electric automobiles or large-sized storage batteries.

In order to improve low power characteristics of all-solid secondary batteries, a thin solid electrolyte such as that disclosed in Japanese Patent Publication No. 2000-340257, a positive electrode active material that has similar properties to the solid electrolyte (i.e., a compound having the same anion such as that disclosed in Japanese Patent Publication No. 2007-324079), a buffer layer on the surface of a positive electrode active material have been disclosed.

Recently, a great deal of research has been made into all-solid secondary batteries including indium (In) as a negative electrode active material and LiCoO₂ as a positive electrode active material. However, the lattice spacing of such positive and negative electrode active materials is changed by the deintercalation of lithium (Li), and the structure thereof is distorted. This changes the volume of the active material. If the volume of an active material in which lithium ions are intercalated and deintercalated between solids is changed, the contact area between the active material and a solid electrolyte is reduced due to gaps formed between the active material and the solid electrolyte. Thus, the migration of lithium ions is inhibited causing deterioration of characteristics of the all-solid secondary battery.

As described above, in order to reduce resistant components in the interface between the positive or negative electrode active material and the solid electrolyte of an all-solid secondary battery, an active material that does not form a resistant layer in the interface by including anions that are in the same group of elements may be used or the generation of resistant components may be inhibited by forming a buffer layer on the surface of active material particles. However, even though by-products caused by the reaction between the solid electrolyte and the active material may be inhibited according to these methods, it is difficult to inhibit the increase in resistance in the interface between the active material and the solid electrolyte caused by internal structure distortion of the active material due to repetitive charging and discharging.

### SUMMARY

Aspects of the invention are an all-solid secondary battery having excellent output characteristics and cycle characteristics, and a positive electrode used therefor.

According to an aspect of the present invention, an all-solid secondary battery includes a negative electrode that includes a negative electrode active material in which lithium ions are intercalatable and deintercalatable, a solid electrolyte layer that includes an inorganic solid electrolyte, and a positive electrode that includes a positive electrode active material in which lithium ions are intercalatable and deintercalatable, wherein the positive electrode active material includes LiMeO₂ having a layered structure, wherein Me includes at least one metal, wherein a variation rate of the lattice constant a and a variation rate of the lattice constant c between LiMeO₂ before the deintercalation of Li and Li1-xMeO₂ (0<X<0.8) after the deintercalation of Li are 1% or less, respectively.

According to another aspect of the present invention, a positive electrode for an all-solid secondary battery includes a positive electrode active material in which lithium ions are intercalatable and deintercalatable, wherein the positive electrode active material includes LiMeO₂ having a layered structure, wherein Me includes at least one metal, wherein a variation rate of the lattice constant a and a variation rate of the lattice constant c between LiMeO2 before the deintercalation of Li and Li₁₋ₓMeO₂ (0<X<0.8) after the deintercalation of Li are 1% or less, respectively.

According to an aspect of the invention, by using LiMeO₂ that has a two-dimensional path of lithium migration and a stable layered structure as the positive electrode active material, the change in the lattice spacing is suppressed during the deintercalation of lithium ions, so that the contact between the positive electrode active material and the solid electrolyte may be maintained well.

According to an aspect of the invention, the path of electron and lithium ion migration is secured between the positive electrode active material particles and the solid electrolyte so that the increase in resistance of the interface between the positive electrode active material and the solid electrolyte may be suppressed.

According to an aspect of the invention, Me may be nickel (Ni), cobalt (Co), aluminum (Al), manganese (Mn), titanium (Ti), magnesium (Mg), or the like.

According to an aspect of the invention, a lithium-metal complex oxide including Al and/or Mg as an essential element may be used.

According to an aspect of the invention, the inorganic solid electrolyte may have a lithium ion conductivity of 10⁻⁴ S/cm or greater.

According to an aspect of the invention, the inorganic solid electrolyte may include at least one selected from the group consisting of Li₃N, LISICON (Lithium Super Ionic Conductor), LIPON (Li_{3+y}PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, and Li₂O—Al₂O₃—TiO₂—P₂O₅ (LATP).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A schematically shows an interface between a solid electrolyte and a positive electrode active material of a general all-solid secondary battery, and FIG. 1B schematically shows an interface between a solid electrolyte and a positive electrode active material of an all-solid secondary battery according to an embodiment of the present invention;

FIG. 2A is a graph illustrating a change in the lattice constant a with respect to capacity change, and FIG. 2B is a graph illustrating a change in the lattice constant c with respect to capacity change; and

FIG. 3 is an all-solid secondary battery according to an embodiment of the invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

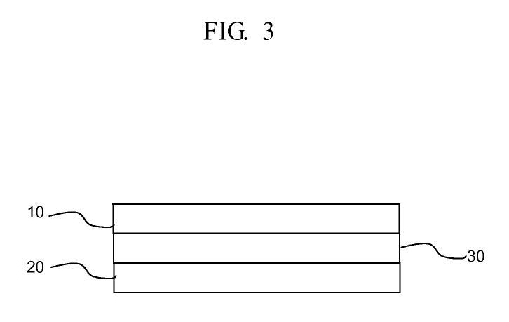

Hereinafter, an all-solid secondary battery according to an embodiment of the present invention will be described in detail with reference to FIG. 3. The all-solid secondary battery according to the present embodiment includes a positive electrode 10, a negative electrode 20, and a solid electrolyte layer 30 that is interposed between the positive electrode 10 and the negative electrode 20. The positive electrode 10 includes a positive electrode active material formed of LiMeO₂ having a layered structure in which lithium ions are intercalatable and deintercalatable, wherein Me includes at least one metal. In the LiMeO₂ according to the present embodiment, a variation rate of the lattice constant a and a variation rate of the lattice constant c between LiMeO₂ before the deintercalation of Li and Li₁₋ₓMeO₂ (0<X<0.8) after the deintercalation of Li are 1% or less, respectively. A lower limit of the variation rate of the lattice constants a and c are not limited, but may be greater than 0%. In particular, the variation rate of the lattice constant a may be in the range of 0.1% to 1%, for example, in the range of 0.15% to 0.5% or 0.15% to 0.30%. In particular, the variation rate of the lattice constant c may be in the range of 0.3% to 1%, for example, in the range of 0.3% to 0.8% or 0.5% to 0.75%.

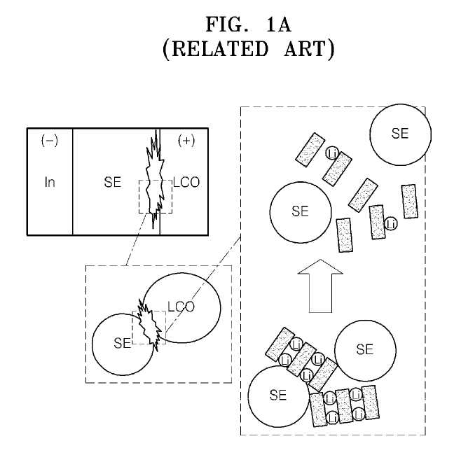

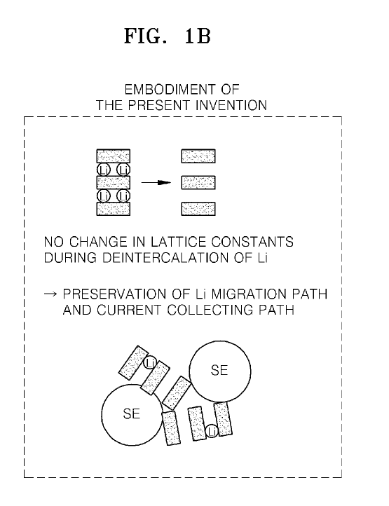

As shown in FIG. 1A, if lithium ions are deintercalated from LiCoO₂ that is used as a positive electrode active material of a general all-solid secondary battery to form Li₁₋ₓCoO₂, the amount of lithium decreases in the lithium layer having a layered structure, and thus the lattice spacing (c axis) increases by repulsion of O—O bonds to distort the layered structure. Thus, the volume of the positive electrode active material is changed so that a gap is formed between the positive electrode active material and a solid electrolyte while repeating charging and discharging, thereby reducing the contact area between the positive electrode active material and the solid electrolyte. Accordingly, the path of electron and lithium ion migration is lost between the positive electrode active material particles and the solid electrolyte so that resistance in the interface therebetween increases. In FIGS. 1A and 1B, the solid electrolyte is shown as ┌SE┘, and LiCoO₂ is shown as ┌LCO┘.

In contrast, since LiMeO₂ having a layered structure, particularly a stable layered structure, is used as the positive electrode active material according to an aspect of the invention, the change in the lattice spacings is suppressed even when lithium ions are deintercalated from LiMeO₂ to form Li₁₋ₓMeO₂ as shown in FIG. 1B. Thus, the contact between the positive electrode active material and the solid electrolyte is maintained well. Accordingly, the path of electron and lithium ion migration is secured between the positive electrode active material particles and the solid electrolyte so that the increase in resistance in the interface between the positive electrode active material and the solid electrolyte may be suppressed.

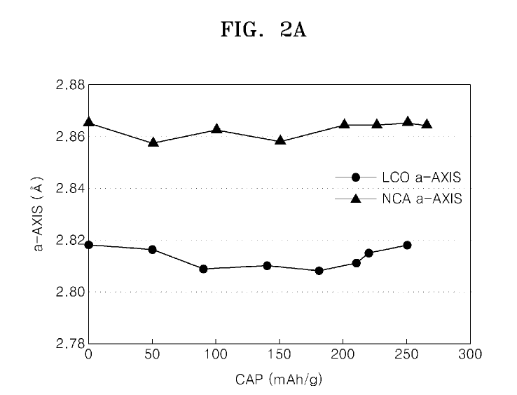

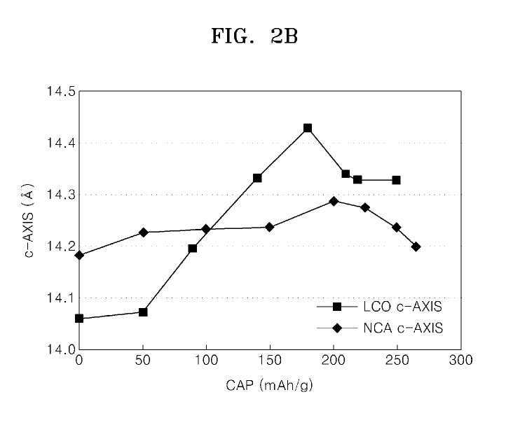

LiNi_{0.8}CO_{0.15}Al_{0.05}O₂ is used as LiMeO₂, and the variations of the lattice constant a of LiCoO₂ and LiMeO₂ according to the deintercalation of lithium ions are shown in FIG. 2A, and the variations of the lattice constant c of LiCoO₂ and LiMeO₂ according to the deintercalation of lithium ions are shown in FIG. 2B. To measure the variations of the lattice constants a and c during charging, the battery was prepared by using Li metal as a negative electrode, and a non-aqueous electrolyte solution prepared by dissolving 1.3M LiPF6 in a mixed solvent consisting of EC (ethylene carbonate):DMC (dimethyl carbonate):MEC (methylethyl carbonate)=2:6:2 (vol %) as an electrolyte solution. The positive electrode was prepared by using a composition including the positive active material: VGCF as a conducting agent: PVDF (polyvinylidene fluoride) as a binder resin=96:2:2 (wt %). The lattice constant of the y axis was measured using a high-power X-ray diffraction device using a Cu target at a voltage of 50 kV, at a current of 300 mA, with a step width of 0.02°, and at a scan rate of 1°/min. The capacity CAP of the x axis corresponds to the amount of deintercalated lithium ions, and 200 mAh/g corresponds to about X=0.7 of the amount of the deintercalated lithium ions. In addition, in FIGS. 2A and 2B, LiNi_{0.8}CO_{0.15}Al_{0.05}O₂ is shown as ┌NCA┘, and LiCoO₂ is shown as ┌LCO┘.

As shown in FIG. 2B, the crystalline stability of LiCoO₂ and LiNi_{0.8}CO_{0.15}Al_{0.05}O₂ in the c axis are significantly different from each other. The lattice spacing of LiCoO₂ rapidly increases until the amount of deintercalated lithium ions reaches about X=0.7, and then decreases so that the lattice spacing proceeds to an irreversible region. Meanwhile, the lattice spacing of LiNi_{0.8}CO_{0.15}Al_{0.05}O₂ is uniformly maintained until the amount of deintercalated lithium ions reaches about X=0.8. The LiMeO₂ used herein may be a lithium-metal complex oxide in which Me is nickel (Ni), cobalt (Co), aluminum (Al), manganese (Mn), titanium (Ti), magnesium (Mg), or the like. Among these, a lithium metal complex oxide including Al or Mg as an essential element may be used. Since aluminum or magnesium may act as a pillar that supports the layered structure of LiMeO₂, the structure of LiMeO₂ may be stably maintained even when the intercalation and deintercalation of lithium ions are repeated. Ti may have the same function as aluminum or magnesium.

Examples of LiMeO₂ may be LiNiₓM1_{y}M2_{z}O₂ (0.5<x<0.9, 0.1<y<0.6, 0.01<z<0.2, wherein M1 is Co and/or Mn, and M2 includes at least one selected from the group consisting of Al, Mg, and Ti. Such a positive electrode active material may be used alone or as a combination of at least two.

In addition, in the LiMeO₂ used herein, since the layered structure may maintained stably as described above, the intercalation and deintercalation of lithium ions do not influence the positive electrode active material particles. In this regard, even though the structure of a positive electrode active material having a spinel structure such as lithium manganate is stably maintained, the positive electrode active material having the spinel structure has low freedom of migration of lithium ions, and thus the capacity of an all-solid secondary battery using it may not be sufficient.

The negative electrode includes a negative electrode active material in which lithium ions are intercalatable and deintercalatable. Any negative electrode active material in which lithium ions are intercalatable and deintercalatable may be used without limitation. For example, the negative electrode active material may be lithium metal; transition metal oxide such as Li₄/3Ti₅/3O₄; and carbonaceous materials such as artificial graphite, graphite carbon fiber, carbon by pyrolysis of vapor grown carbon, coke, mesocarbon microbeads (MCMB), carbon by pyrolysis of furfuryl alcohol resin, polyacene, pitch-based carbon fiber, vapor grown carbon fiber, natural graphite, and hard carbon. Among these, negative electrode active materials having a layered structure may be used. Such a negative electrode active material may be used alone or as a combination of at least two.

While not required in all aspects, the positive electrode and negative electrode may be prepared by optionally adding additives such as a conducting agent, a binder, an electrolyte, a filling agent, a dispersant, and an ion conductor to powders of the active materials. The conducting agent may be graphite, carbon black, acetylene black, ketjen black, carbon fiber, metal powder, or the like. The binder may be an acrylic resin, polytetrafluoroethlyene (PTFE), polyvinylidene fluoride (PVDF), polyethylene, or the like. The electrolyte may be an inorganic solid electrolyte that will be described later.

The positive electrode or negative electrode may be prepared by preparing a mixture including the active material described above and various additives and hydraulically pressing the mixture to form a thick and dense pellet. Alternatively, the positive electrode or negative electrode may be prepared by forming a slurry or paste of the active material described above and various additives by adding a solvent such as water or an organic solvent thereto, coating the slurry or paste on a current collector using for example, a doctor blade, drying the coating, and pressing the dried coating using a press roll.

The current collector may be a plate or foil that is formed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Alternatively, the positive electrode or the negative electrode may be prepared by press molding the active material to form a pellet without using the binder. In addition, if a metal or an alloy thereof is used as the negative electrode active material, a metal sheet thereof may be used as the negative electrode.

The solid electrolyte layer includes the lithium ion conductor including an inorganic compound as an inorganic solid electrolyte. Examples of the lithium ion conductor are Li₃N, LISICON, LIPON (Li_{3+y}PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li2O-Al2O3-TiO₂—P2O5 (LATP), or the like. The inorganic compound may have a crystalline, amorphous, glass, or glass ceramics structure. Among theses inorganic solid electrolytes, amorphous Li₂S—P₂S₅, glass ceramics, or LiAlTiPOx having lithium ion conductivity of 10⁻⁴ S/cm or greater may be used.

The all-solid secondary battery according to the present embodiment may be prepared by stacking the positive electrode, the solid electrolyte layer, and the negative electrode and pressing the stacked materials.

### EXAMPLES

Hereinafter, one or more embodiments will be described in detail with reference to the following examples. However, theses examples are not intended to limit the purpose and scope of the invention.

### Example 1

LiNi_{0.8}CO_{0.15}Al_{0.05}O₂ was used as a positive electrode active material. LiNi_{0.8}CO_{0.15}Al_{0.05}O₂ has a variation rate of the lattice constant a of 0.2% and a variation rate of the lattice constant c of 0.7% when Li was deintercalated up to about X=0.7. Amorphous Li₂S—P₂S₅ (80-20 mol %) that was synthesized by mechanical milling was used as a solid electrolyte. Graphite was used as a negative electrode active material. A composition including the positive electrode active material, the solid electrolyte, and a vapor grown carbon fiber (VGCF) as a conducting agent at a ratio of 60:35:5 wt % was used for preparing the positive electrode. A composition including the negative electrode active material, the solid electrolyte, and a vapor grown carbon fiber (VGCF) as a conducting agent at a ratio of 60:35:5 wt % was used for preparing the negative electrode. Then, the positive electrode composition, the solid electrolyte, and the negative electrode composition were sequentially stacked and pressed to prepare an all-solid secondary battery.

The variation rates of the lattice constants a and c of the positive electrode active material were respectively calculated by measuring the lattice constants a and c using a high-power X-ray diffraction device with a Cu target at a voltage of 50 kV, at a current of 300 mA, with a step width of 0.02°, and at a scan rate of 1°/min before charging and after a first charging. To measure the variations of the lattice constants a and c during charging, the battery was prepared by using Li metal as a negative electrode, and an electrolyte solution prepared by dissolving 1.3M LiPF6 in a mixed solvent consisting of EC:DMC:MEC=2:6:2 (vol %) as an electrolyte solution. The positive electrode was prepared by using a composition including the positive active material: VGCF as a conducting agent: PVDF as a binder resin=96:2:2 (wt %).

The all-solid secondary battery was set such that 1 C=1.4 mA and discharged while currents of 0.1 C, 0.3 C, 0.5 C, and 1 C were supplied to evaluate output characteristics of the all-solid secondary battery based on a capacity retention rate which is equal to the ratio of the capacity when the amount of the current is 1 C to the capacity when the amount of the current is 0.1 C. In addition, a capacity retention rate after charging at 0.1 C and discharging at 0.5 C 50 times of was regarded as a cycle retention rate, and cycle characteristics were evaluated using the cycle retention rate.

### Example 2

An all-solid secondary battery was prepared in the same manner as in Example 1, except that LiNi_{0.77}CO_{0.15}Al_{0.08}O₂ was used as the positive electrode active material, and characteristics of the all-solid secondary battery were evaluated.

### Example 3

An all-solid secondary battery was prepared in the same manner as in Example 1, except that LiNi_{0.76}CO_{0.14}Al_{0.10}O₂ was used as the positive electrode active material, and characteristics of the all-solid secondary battery were evaluated.

### Example 4

An all-solid secondary battery was prepared in the same manner as in Example 1, except that LiNi_{0.45}CO_{0.45}Al_{0.10}O₂ was used as the positive electrode active material, and characteristics of the all-solid secondary battery were evaluated.

### Example 5

An all-solid secondary battery was prepared in the same manner as in Example 1, except that LiNi_{0.76}CO_{0.14}Al_{0.05}Mg_{0.05}O₂ was used as the positive electrode active material, and characteristics of the all-solid secondary battery were evaluated.

### Comparative Example 1

An all-solid secondary battery was prepared in the same manner as in Example 1, except that LiCoO₂ was used as the positive electrode active material, and characteristics of the all-solid secondary battery were evaluated.

### Comparative Example 2

An all-solid secondary battery was prepared in the same manner as in Example 1, except that LiNiO₂ was used as the positive electrode active material, and characteristics of the all-solid secondary battery were evaluated.

The results of Examples 1 to 5 and Comparative Examples 1 and 2 are shown in Table 1 below.

TABLE 1

| | Variation rates of the | | | |
|---|---|---|---|---|
| | lattice constants (%) | | Output | Cycle |
| | c | a | characteristics (%) | characteristics (%) |
| Example 1 | 0.70 | 0.20 | 60.8 | 86.8 |
| Example 2 | 0.65 | 0.20 | 62.7 | 83.5 |
| Example 3 | 0.60 | 0.20 | 64.1 | 90.1 |
| Example 4 | 0.65 | 0.25 | 60.2 | 82.3 |
| Example 5 | 0.63 | 0.20 | 63.4 | 88.7 |
| Comparative | 2.90 | 0.35 | 22.1 | 26.0 |
| Example 1 | | | | |
| Comparative | 1.70 | 0.25 | 26.3 | 43.2 |
| Example 2 | | | | |

In the all-solid secondary batteries including the lithium ion conductive inorganic solid electrolyte prepared according to Examples 1 to 5, active materials having a layered structure in which lithium ions are intercalatable and deintercalatable are used in the positive electrode and negative electrode and an active material having the lattice constants a and c with variation rates of 1% or less when Li, as a positive electrode active material, was deintercalated up to about 0.8, are used. Thus, the increase in resistance of the interface between the positive electrode active material and the solid electrolyte may be suppressed, and high stability of the structure may be maintained even when charging and discharging are repeated many times, and therefore, the all-solid secondary batteries may have excellent output characteristics and cycle characteristics.

Abbreviations

SE: Solid electrolyte

LCO: LiCoO₂

NCA: LiNi_{0.8}CO_{0.15}Al0.05O₂

As described above, according to one or more of the above embodiments of the present invention, an all-solid secondary battery that has high stability and excellent output characteristics and cycle characteristics may be obtained by inhibiting the resistance of the interface between the positive electrode active material and the solid electrolyte.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An all-solid secondary battery comprising:
a negative electrode that comprises a negative electrode active material in which lithium ions are intercalatable and deintercalatable;
a solid electrolyte layer that comprises an inorganic solid electrolyte; and
a positive electrode that comprises a positive electrode active material in which lithium ions are intercalatable and deintercalatable, the positive electrode active material comprising LiMeO₂ having a layered structure,
wherein:
Me comprises at least one metal, and
a variation rate of a lattice constant a and a variation rate of a lattice constant c between LiMeO₂ before the deintercalation of Li and Li₁₋ₓMeO₂ (0<X<0.8) after the deintercalation of Li are 1% or less, respectively.

2. The all-solid secondary battery of claim 1, wherein the Me comprises at least one metal element selected from the group consisting of nickel (Ni), cobalt (Co), aluminum (Al), manganese (Mn), titanium (Ti), and magnesium (Mg).

3. The all-solid secondary battery of claim 1, wherein the Me comprises nickel (Ni), a first metal element, and a second metal element, the first metal element being at least one metal element selected from the group consisting of cobalt (Co), and/or manganese (Mn), and the second metal element being at least one metal element selected from the group consisting of titanium (Ti), aluminum (Al), and/or magnesium (Mg).

4. The all-solid secondary battery of claim 1, wherein the inorganic solid electrolyte comprises a lithium ion conductivity of 10⁻⁴ S/cm or greater.

5. The all-solid secondary battery of claim 4, wherein the inorganic solid electrolyte comprises at least one selected from the group consisting of Li₃N, LISICON (Lithium Super Ionic Conductor), LIPON (Li_{3+y}PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, and Li₂O—Al₂O₃—TiO₂—P₂O₅ (LATP).

6. A positive electrode for an all-solid secondary battery comprising a positive electrode active material in which lithium ions are intercalatable and deintercalatable, the positive electrode active material comprising LiMeO₂ having a layered structure,
wherein:
Me comprises at least one metal, and
a variation rate of a lattice constant a and a variation rate of a lattice constant c between the LiMeO₂ before the deintercalation of Li and Li₁₋ₓMeO₂ (0<X<0.8) after the deintercalation of Li are 1% or less, respectively.

7. The positive electrode of claim 6, wherein the Me comprises at least one metal element selected from the group consisting of nickel (Ni), cobalt (Co), aluminum (Al), manganese (Mn), titanium (Ti), and magnesium (Mg).

8. The positive electrode of claim 6, wherein the Me comprises nickel (Ni), a first metal element, and a second metal element, the first metal element being at least one metal element selected from the group consisting of cobalt (Co), and/or manganese (Mn), and the second metal element being at least one metal element selected from the group consisting of titanium (Ti), and aluminum (Al), and/or magnesium (Mg).
